(19) United States
(12) Patent Application Publication
(10) Pub. No.: US 2024/0355092 A1
(43) Pub. Date: Oct. 24, 2024

(54) SYSTEMS AND METHODS FOR ADVANCED HIERARCHICAL MODEL ANALYSIS

(71) Applicant: State Farm Mutual Automobile Insurance Company, Bloomington, IL (US)

(72) Inventors: Geetha P. Nagarajan, Plano, TX (US); Reuven Birnbaum, Urbana, IL (US); Salomon K. Kabongo, Bloomington, IL (US)

(21) Appl. No.: 18/621,668

(22) Filed: Mar. 29, 2024

Related U.S. Application Data
(60) Provisional application No. 63/497,619, filed on Apr. 21, 2023.

(51) Int. Cl. G06V 10/764; G06V 10/94; G06V 20/10

(52) U.S. Cl. CPC G06V 10/764; G06V 10/94; G06V 20/176

(57) ABSTRACT

A computer system is provided and is programmed to: (1) receive a plurality of images; and/or (2) for each image of the plurality of images, the at least one processor is programmed to: (a) retrieve an image of the plurality of images; (b) execute a hierarchy of models with the retrieved image as input; (c) output classification information for the retrieved image based upon the execution; and/or (d) associate the classification information with the retrieved image.

### CROSS-REFERENCE TO RELATED APPLICATIONS

This application claims priority to U.S. Provisional Patent Application No. 63/497,619, filed Apr. 21, 2023, entitled “SYSTEMS AND METHODS FOR ADVANCED HIERARCHICAL MODEL ANALYSIS,” the entire contents and disclosures of which are hereby incorporated herein by reference in their entirety.

### FIELD OF THE DISCLOSURE

The present disclosure relates to advanced hierarchical model analysis, and more particularly, to a network-based system and method for analyzing and classifying images using a hierarchical series of models.

### BACKGROUND

Digital images (e.g., photos and/or videos) are oftentimes captured by cameras and stored on memory. In some cases, those digital images are shared with other systems that may process those images further. In some cases, those images may need to be evaluated before being shared so that the information included in the images is better understood and/or labeled so that the further processing may happen. Evaluation of such images may be a labor-intensive process and may be dependent upon subject matter expertise.

Using known systems for evaluating an image, it is understood that the more complicated the image, the greater the likelihood may be that the image will be mis-labeled or mis-identified. Also, using the known systems for image analysis, the more complicated the image, the more computation resources may be needed to evaluate the image. In many cases, the images may contradict some information provided through another means. This may occur as a result of information being updated after the picture was captured.

Generating and training a single model that can handle all of the potential details in analyzing images may be overly large, complicated, and difficult to use and may require significant computing resources. Furthermore, adding the capability to handle new details may be difficult and the single model may become unwieldy to use. Accordingly, a more resource efficient system and/or method for image analysis systems would be desirable. Conventional techniques may have additional encumbrances, inefficiencies, ineffectiveness, and drawbacks as well.

### BRIEF SUMMARY

The present embodiments may relate to, inter alia, systems and methods for advanced hierarchical model analysis, and more particularly, to a network-based system and method for analyzing and classifying images using a hierarchical series of models. The systems and methods described herein may provide for analyzing and classifying a plurality of images of a property to glean characteristics of the property from the images. The present systems and methods may further include a plurality of classification models that are configured in a hierarchical architecture, where the images are routed to different classification models based upon the classifications from previous models.

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include a computing device that may include at least one processor in communication with at least one memory device. The at least one processor may be configured to: (1) receive a plurality of images; and/or (2) for each image of the plurality of images, the at least one processor is programmed to: (a) retrieve an image of the plurality of images; (b) execute a hierarchy of models with the retrieved image as input; (c) output classification information for the retrieved image based upon the execution; and/or (d) associate the classification information with the retrieved image. The computer system may include additional, less, or alternate functionality, including that discussed elsewhere herein.

In another aspect, a computer-implemented method may be provided. The computer-implemented method may be performed by a hierarchical model image analysis (HMIA) computer device including at least one processor in communication with at least one memory device. The method may include: (1) receiving a plurality of images; and/or for each image of the plurality of images, the method further comprises: (a) retrieving an image of the plurality of images; (b) executing a hierarchy of models with the retrieved image as input; (c) outputting classification information for the retrieved image based upon the execution; and/or (d) associating the classification information with the retrieved image. The computer-implemented method may include additional, less, or alternate actions, including those discussed elsewhere herein.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) receive a plurality of images; and/or (2) for each image of the plurality of images, the at least one processor is programmed to: (a) retrieve an image of the plurality of images; (b) execute a hierarchy of models with the retrieved image as input; (c) output classification information for the retrieved image based upon the execution; and/or (d) associate the classification information with the retrieved image. The computer-executable instructions may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a simplified block diagram of an exemplary process for analyzing and categorizing a plurality of images using a hierarchical model image analysis system, in accordance with at least one embodiment.

FIG. 2 illustrates a block diagram of an exemplary hierarchical model image analysis system, in accordance with at least one embodiment.

FIG. 3 illustrates an exemplary process of classifying a plurality of images usings the hierarchical model image analysis system shown in FIG. 2.

FIG. 4 illustrates an exemplary system for performing the process shown in FIG. 3 using the hierarchical model image analysis system shown in FIG. 2.

FIG. 5 illustrates an exemplary configuration of a user computer device, in accordance with one embodiment of the present disclosure.

FIG. 6 illustrates an exemplary configuration of a server computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for advanced hierarchical model analysis, and more particularly, to a network-based system and method for analyzing and classifying images using a hierarchical series of models. In one exemplary embodiment, the process may be performed by a hierarchical model image analysis (“HMIA”) computer device. In the exemplary embodiment, the HMIA computer device may be in communication with one or more client devices and one or more third-party information sources. As described below in further detail, the HMIA computer system includes multiple, image evaluating models that are distributed in a hierarchical manner such that an image is evaluated by a series of models that identify additional details in the image as each model is applied. The output from a first model is fed into the next model and/or is used in the selection of the next model so that the labels and/or description of the image that are generated describing the image are continuously built and enhanced as the image progresses through the models. By using this distributed, hierarchical model set for image analysis, the output describing the content of the image is significantly improved (e.g., both accuracy and detail), computational resources are conserved, and the system is more easily updated by adding or changing our one or more of the models.

In the exemplary embodiment, the HMIA computer device is configured to take images of a property and glean characteristics of the property from the images. The pictures may include exterior and interior images. In the exemplary embodiment, the HMIA computer device includes a plurality of models in a hierarchical architecture, wherein the hierarchical architecture routes different images to different models based upon the results of previous models. For example, a first model may determine if the image is an inside or outside image. If the output of the first model indicates that the image is from the inside of a building on the property, the HMIA computer device may route the image to a second model that determines what room in the property that the image is from. If the output of the first model indicates that the image is of the outside of the property, the HMIA computer device may route the image to one or more second models to determine what is in the image, (e.g., roof, siding, pool, etc.). For each of the models that processes the image, the output includes one or more classifications of the image. These classifications may include, but are not limited to, location (inside/outside, front/back yard, room, etc.), materials in the image (siding type, roofing type, floor type), and makes/models of fixtures, features, and appliances in the image. In the exemplary embodiment, the classifications are associated with the image, such as through metadata. In some embodiments, the image and classifications are stored in a database to allow for searching of the images based upon their classifications. In some further embodiments, the plurality of models may include models trained to perform object detection and image segmentation. These models not only classify the content of the image, but also localizes the image with a bounding box and/or area.

The distributed nature of the models advantageously provides more accurate and detailed outputs than a single large classification model. To be able to train a single model in identifying and/or classifying a plurality of different details in a plurality of different images, requires significant resources and the model needs to make connections for each of the details to be identified. In contrast, a plurality of distributed models may be used as described herein to more quickly and efficiently be trained and executed to identify and/or classify details in the plurality of images. Furthermore, by using a plurality of distributed models, additional models may be added the hierarchical structure to identify other details.

In further embodiments, the output of one model may be used as an input into the next model to assist the model in classification of the related image. Furthermore, the outputs of the plurality of executed models may then be combined and/or aggregated together to create a final output.

In some embodiments, the hierarchical structure may be managed by one or more orchestrator computer devices, wherein the orchestrator computer devices determine which models to route the images to based upon the outputs of other models. The HMIA computer device may be considered an orchestrator. This orchestrator may direct the image through the hierarchical process and may also generate a final output by aggregating the results of the executed models.

In some embodiments, the models may output classifications of images and a confidence score associated with the classifications. For example, the inside/outside model may provide a confidence score that the corresponding image is of the inside and/or outside of the house. The HMIA computer device may then decide which model to route the image to based upon the corresponding confidence levels.

In some embodiments, the classifications of images may be used to identify specific images. For example, the HMIA computer device may use the classification to determine which image is of the front of the house and then use that image for a report.

In additional embodiments, the classifications of images may be used to create reports, real estate listings, and used in other data collection. The classifications of the images may also be used to validate information provided from third party sources. For example, a tax report may list the property as having two bedrooms, but the classifications may have detected three bedrooms in the images. This may be an indicator of unreported modifications to the property. In at least one embodiment, the classification of image is used to create a written description of the property. This written description may be created using natural language processing. In some embodiments, the output is stored in the memory of one or more computer devices. In additional embodiments, the output is used to generate a user interface to be displayed to one or more users.

In some embodiments, the classifications of the images may be used for insurance purposes. The images may be provided to an insurer, where the insurer may use the images to determine a pre-incident condition of the property. The insurer may also use the images to determine appliances and/or other features/fixtures of the property that need to be replaced and/or valued.

In the exemplary embodiment, the HMIA server receives a plurality of images. In at least one embodiment, the plurality of images are associated with a property, such as, but not limited to, a home, a rental unit, a building, and/or any other property. In some embodiments, the plurality of images are received from a camera device associated with a client device, such as a mobile phone. In other embodiments, the plurality of images are received from a third-party source, such as a third-party server. This plurality of images may be from one or more websites, such as websites for the sale and/or rental of property. In still further embodiments, the plurality of images are received from one or more databases.

In the exemplary embodiment, the HMIA server executes a plurality of image classification models using the plurality of images as inputs. The plurality of image classification models are each trained to identify different features of a property (or other item), such as a building. For example, one image classification model is trained to recognize distinct types of roofs and then classify the type of roof in provided images, for example, but not limited to, gable roof, clipped gable roof, Dutch gable roof, Gambrel Roof, Hip Roof, Mansard Roof, Shed Roof, and Flat Roof (Low Slope Roof). The roof classification model may also be able to determine the type of materials used in the construction of the roof, such as, but not limited to, rolled roofing, built-up roofing, membrane roofing, asphalt composite shingles, standing seam metal roofing, metal shingles/shakes, wood shingles/shakes, clay tile, concrete tile, slate shingles, synthetic (rubber) slate tile, and a living roof. Other image classification models may be trained to recognize different features of the building, such as, but not limited to, siding materials, room types, pools, decks, windows, floors, ceilings, walls, doors, furniture, fixtures, tiles, appliances, and/or any other features of the building that may be desired to be recognized and/or analyzed. In some embodiments, one image classification models may be trained using synthetic data to increase the dataset and to include any know edge cases that may have a low frequency of occurrence.

The plurality of image classification models output classification results for each of the provided plurality of images. The classification results include the classification information for each of the plurality of images. Each image may include a plurality of classifications. For example, an image of a kitchen may include a classification (or label) that the image is inside the building, on the first floor, is a kitchen, has a brand/model refrigerator, has a backsplash of a specific type of tile, has a gas stove of a particular brand/model, has a particular type of window, and has a hardwood floor, based upon what is in the image itself.

The image classification results (output) for each of the plurality of images applied to an image are combined to create the analysis results (aggregated output) for the plurality of images. In some embodiments, the analysis results may be used to validate provided information about the property. In other embodiments, the analysis results may be used generate a description of the property. In still further embodiments, the analysis results may be used to detect one or more desired images, such as an image of the front of the property.

Once the plurality of images are classified, the classification results may be associated with and stored with the corresponding images. In some embodiments, the classifications may be stored as metadata for the corresponding images. These allows systems to retrieve the images later and access their classification data. Furthermore, the images may be stored in one or more databases so that users may search for the images based upon the classification information.

While the above describes using the systems and processes described herein for analyzing property, one having skill in the art would understand that these systems and methods may also be used for classifying items, such as vehicles, antiques, and/or other objects that need to be analyzed and classified.

At least one of the technical problems addressed by this system may include: (i) large amounts of training data required to create a single image classification model; (ii) inability to accurately classify an image using a single classification model; (iii) computational delays in applying a single classification model to all images; (iv) inability to validate information included in an image; (v) limited classification options analysis systems; (vi) inability to distribute classification resources when analyzing images; (vii) inability to easily update and/or change models being used to analyze images; (viii) significant resources required for training, updating, and executing large model; and/or reduced efficiency and accuracy when dealing with a single large model.

A technical effect of the systems and processes described herein may be achieved by performing at least one of the following steps: (i) receiving a plurality of images; (ii) retrieving an image of the plurality of images; (iii) executing a hierarchy of models with the retrieved image as input; (iv) outputting classification information for the retrieve image based upon the execution; and (v) associating the classification information with the retrieved image.

### Exemplary Process for Analyzing and Classifying Images

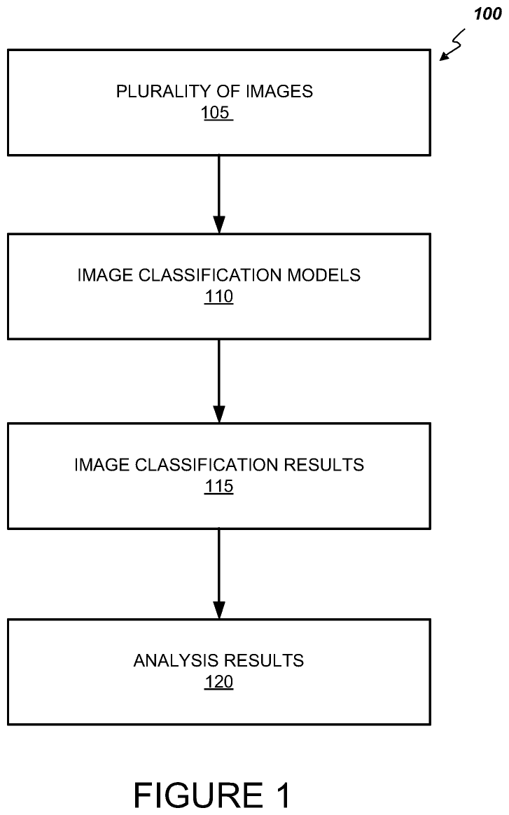

FIG. 1 illustrates a simplified block diagram of an exemplary process 100 for analyzing and categorizing a plurality of images using a hierarchical model image analysis system, in accordance with at least one embodiment. In at least one embodiment, process 100 is performed by a hierarchical model image analysis (HMIA) server 410 (also known as a hierarchical model image analysis (HMIA) computer device 410.

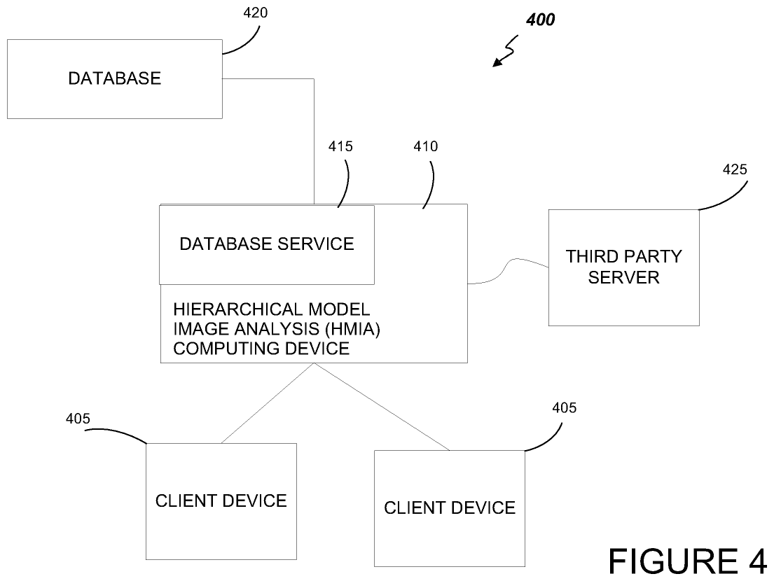

In the exemplary embodiment, the HMIA server 410 receives a plurality of images 105. In at least one embodiment, the plurality of images 105 are associated with a property, such as, but not limited to, a home, a rental unit, a building, and/or any other property. In some embodiments, the plurality of images 105 are received from a camera device associated with a client device 405 (shown in FIG. 4), such as a mobile phone. In other embodiments, the plurality of images 105 are received from a third-party source, such as a third-party server 425 (shown in FIG. 4). This plurality of images 105 may be from one or more websites, such as websites for the sale and/or rental of property. In still further embodiments, the plurality of images 105 are received from one or more databases, such as database 420 (shown in FIG. 4). In some embodiments, the plurality of images 105 are from one or more videos, where the videos are of the property. In an additional embodiment, the plurality of images 105 may be from a walkthrough or three-dimensional (3D) tour of the building and/or property.

In the exemplary embodiment, the HMIA server 410 executes a plurality of image classification models 110 using the plurality of images 105 as inputs. The plurality of image classification models 110 are each trained to identify distinctive features of property, such as a building. For example, one image classification model is trained to recognize distinct types of roofs and then classify the type of roof in provided images, for example, but not limited to, gable roof, clipped gable roof, Dutch gable roof, Gambrel Roof, Hip Roof, Mansard Roof, Shed Roof, and Flat Roof (Low Slope Roof). The roof classification model may also be able to determine the type of materials used in the construction of the roof, such as, but not limited to, rolled roofing, built-up roofing, membrane roofing, asphalt composite shingles, standing seam metal roofing, metal shingles/shakes, wood shingles/shakes, clay tile, concrete tile, slate shingles, synthetic (rubber) slate tile, and a living roof. Other image classification models may be trained to recognize different features of the building, such as, but not limited to, siding materials, room types, pools, decks, windows, floors, ceilings, walls, doors, furniture, fixtures, tiles, appliances, and/or any other features of the building that may be desired to be recognized and/or analyzed.

The plurality of image classification models 110 output classification results 115 for each of provided plurality of images 105. The classification results 115 include the classification information for each of the plurality of images 105. Each image may include a plurality of classifications. For example, an image of a kitchen may include a classification that image is inside the building, on the first floor, is a kitchen, has a brand/model refrigerator, has a backsplash of a specific type of tile, has a gas stove of a particular brand/model, has a particular type of window, and has a hardwood floor, based upon what is in the image itself.

The image classification results 115 for each of the plurality of images 105 are combined to create the analysis results 120 for the plurality of images 105. In some embodiments, the analysis results 120 may be used to validate provided information about the property. In other embodiments, the analysis results 120 may be used generate a description of the property. In still further embodiments, the analysis results 120 may be used to detect one or more desired images, such as an image of the front of the property.

Once the plurality of images 105 are classified, the classification results 115 may be associated with and stored with the corresponding images. In some embodiments, the classifications may be stored as metadata for the corresponding images. These allows systems to retrieve the images later and access their classification data. Furthermore, the images may be stored in one or more databases so that users may search for the images based upon the classification information.

While the above describes using the systems and processes described herein for analyzing property, one having skill in the art would understand that these systems and methods may also be used for classifying items, such as vehicles, antiques, and/or other objects that need to be analyzed and classified.

### Exemplary System for Hierarchical Model Image Analysis

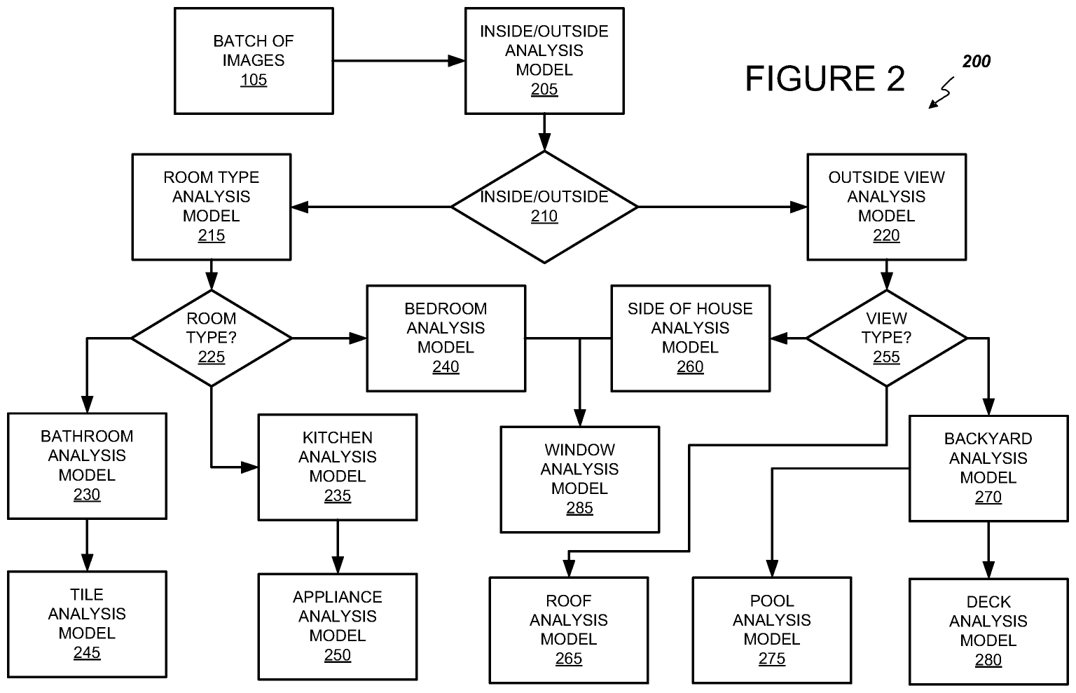

FIG. 2 illustrates a block diagram of an exemplary hierarchical model image analysis (HMIA) system 200, in accordance with at least one embodiment. The HMIA system 200 described herein includes a plurality of classification models, where the output of one classification model is used to determine with classification model to route the image to next.

The HMIA system 200 receives a plurality of images 105 as described above in FIG. 1. In the exemplary embodiment, the plurality of images 105 are related to the same property, item, place, person, and/or other desired object to be analyzed and classified. For the purposes of this discussion, the HMIA system 200 is configured to analyze and classify properties, such as homes. However, one having skill in the art would understand that other objections could be examined using the HMIA system 200 based upon what the different models are configured to classify.

In the exemplary embodiment, the HMIA system 200 receives a plurality of images 105 of a property to be analyzed. In some embodiments, the plurality of images 105 is provided by a user via a client device 405 (shown in FIG. 4). In other embodiments, the plurality of images 105 is provided by a third-party source, such as the third party server 425 (shown in FIG. 4). In one example, the plurality of images 105 are from a website, such as realty website.

The HMIA system 200 routes the plurality of images 105 to an inside/outside analysis model 205. In some embodiments, all of the plurality of images 105 are routed to the inside/outside analysis model 205 all at the same time. In another embodiment, the plurality of images 105 are routed to the inside/outside analysis model 205 one at a time. The inside/outside analysis model 205 is trained to classify images as either inside or outside of a building. This classification model may be for any division that is desired to route the images to distinct types of classification models. For example, in a vehicle analysis embodiment, the first classification model may determine a type of vehicle (sedan, pick-up truck, van, etc.) and then route the image to models that will allow for classification of that vehicle type.

The inside/outside analysis model 205 executes with the image as the input and then outputs the classification of the image. In this case, the classification is inside or outside, but multiple classifications may occur based upon the training of the model. The HMIA system 200 determines 210 whether the image is inside or outside from the output classification of the model. Then the HMIA system 200 routes the image to either the room type analysis model 215 and the other models related to the inside of the building or the outside view analysis model 220 and the other models related to the outside of the building.

For an inside image, the HMIA system 200 routes 225 the image to the room type analysis model 215, that is trained to recognize the type of room that the image is of (e.g., bedroom, bathroom, kitchen, living room, etc.) The room type analysis model 215 classifies the room type based upon information in the image. Then the HMIA system 200 routes the image to the model for the particular room type, such as, but not limited to, a bathroom analysis model 230, a kitchen analysis model 235, and/or a bedroom analysis model 240. These analysis models 230, 235, and 240 are trained to pull out information about the room shown in the image. In some embodiments, the analysis models 230, 235, and 240 are able to tell if the individual room has been seen and classified in other images and/or if this image is off a different room of the same type. For example, a property may have three bedrooms. The HMIA system 200 may have already analyzed and classified images of the first and second bedrooms. The bedroom analysis model 240 may then determine if the next image of a bedroom is one of the other two bedrooms or if the image is of the third bathroom and assign that classification to the image. The analysis models 230, 235, and 240 may also determine different objects in the room, such as, but not limited to, furniture, appliances, fixtures, and/or materials. For example, the bedroom analysis model 240 may determine that there is a bed, a dresser, carpet, and a ceiling fan in the image. Then the bedroom analysis model 240 classifies the image with those three classifications.

The HMIA system 200 then routes the image to additional analysis models based upon the provided classifications. For example, if the bathroom analysis model 230 detects tile in the image of the bathroom, the HMIA system 200 routes the image to tile analysis model 245. In an additional example, the HMIA system 200 may route the image to the appliance analysis model 250 to determine the exact appliances in the image of the kitchen. In some embodiments, there may be a separate analysis model for each type of appliance, where the separate analysis models may determine the brand/make/model of the appliances of that type. In some further embodiments, the appliance models may be broken down by type of appliance, such as for a refrigerator may include, but is not limited to, a top freezer, a bottom freezer, French door, and/or side-by-side and then from there determine the brand/make/model of the appliance.

Furthermore, the HMIA system 200 may route the same image to multiple models. In the above bedroom example, the same image may be routed to a bed analysis model, a dresser analysis model, a carpet analysis model, and/or a ceiling fan analysis model. The HMIA system 200 then collects the classifications of each of the models for the image.

For an outside image, the HMIA system 200 routes the image to the view type analysis model 220, that is trained to recognize the type of view that the image is of (e.g., backyard, roof, front yard, side of house, etc.) The view type analysis model 220 classifies the view type based upon information in the image. Then the HMIA system 200 routes 255 the image to the model for the view type, such as, but not limited to, a side of house analysis model 260, a roof analysis model 265, and/or a backyard analysis model 270. These analysis models 260, 265, and 270 are trained to pull out information about the view shown in the image. In some embodiments, the analysis models 260, 265, and 270 are able to detect additional objects in the corresponding view and classify those objects for the HMIA system 200.

The HMIA system 200 then routes the image to additional analysis models based upon the provided classifications. For example, if the backyard analysis model 270 detects a pool or a deck in the backyard, the HMIA system 200 routes the image to pool analysis model 275 and/or the deck analysis model 280. In an additional example, the HMIA system 200 may route the image to analysis models to detect different types of material. For example, the roof analysis model 265 may determine the type of roof on the building and an additional analysis model is used to determine the roofing material used. In another example, the side of the house analysis model 260 may determine that there is siding on the house and the HMIA system 200 routes the image to a siding analysis model to determine the type of siding on the house.

Furthermore, in some embodiments, multiple models may lead to the same model. For example, the bedroom analysis model 240 may detect one or more windows in the image and the HMIA system 200 routes the image to the window analysis model 285. For another image, the side of house analysis model 260 may detect windows and the HMIA system 200 also routes that image to the window analysis model 285. The window analysis model 285 may detect the type, brand, make, and/or other information about the windows based upon its training.

In some embodiments, an image may include multiple types of views. For example, a view of a front of a house may also include a view of the roof of the house. In another example, a view of a backyard may also include a view of a side of the house.

In some embodiments, images may overlap and/or have duplicate details. For example, there may be two images of a refrigerator at different angles. The plurality of models and/or the HMIA system 200 may recognize the duplication and determine that there is only one refrigerator instead of two in the building. Or the HMIA system 200 may determine that there are two different refrigerators based upon the images having different details showing that the images are from different rooms.

In some further embodiments, the plurality of models may include models trained to perform object detection and image segmentation. These models not only classify the content of the image, but also localizes the image with a bounding box and/or area.

In some embodiments, the classification models and the images may be used to generate a three-dimensional (3D) model of the building and/or property. The images may be analyzed and classified to determine where in the building that they are and/or where the rooms are in relation to each other. The classification models and images may be used to generate blueprints of the building and/or property as the HMIA system 200 determines where each image is relative to each other image based upon information gained from the images. This may also allow the HMIA system 200 to eliminate overlap in the images when generating a continuous view.

In further embodiments, the classifications models may be divided into tiers based upon the classification information that they provide and the analysis models that images may be routed from. For example, the inside/outside analysis model 205 may be a first tier model. The room type analysis model 215 and outside view analysis model 220 may be second tier models. The individual room type 230, 235, and 240 and view type models 260, 265, and 270 would be third tier models. And the materials-based models 245, 250, 275, 280, and 285 would be fourth tier models. These models may be reconfigured based upon their training and the configuration of the HMIA system 200.

In some embodiments, the HMIA system 200 includes one or more models that determine whether or not the image is in focus, is a good quality image, has good lighting, and/or is at a good angle.

In some embodiments, the HMIA system 200 may receive feedback from one or more users, such as through a client device 405 (shown in FIG. 4), wherein the feedback may be used to further train and/or update one or more of the models.

In further embodiments, the output of one model may be used as an input into the next model to assist the model in classification of the related image. Furthermore, the outputs of the plurality of executed models may then be combined and/or aggregated together to create a final output.

In some embodiments, the hierarchical structure may be managed by one or more orchestrator computer devices, wherein the orchestrator computer devices determine which models to route the images to based upon the outputs of other models. The HMIA computer device 410 (shown in FIG. 4) may be considered an orchestrator. This orchestrator may direct the image through the hierarchical process and may also generate a final output by aggregating the results of the executed models.

Exemplary Process for Classifying Images with a Hierarchical Model Image Analysis System

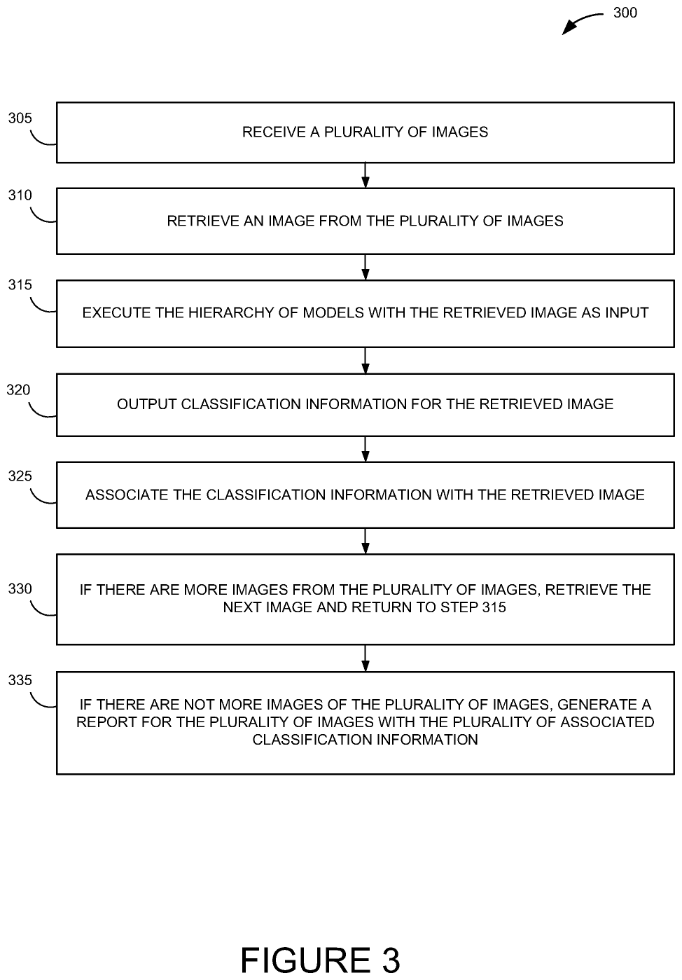

FIG. 3 illustrates an exemplary process 300 of classifying a plurality of images usings the hierarchical model image analysis system 200 (shown in FIG. 2). In the exemplary embodiment, process 300 is performed by HMIA server 410 (shown in FIG. 4).

In the exemplary embodiment, the HMIA server 410 receives 305 a plurality of images 105 (shown in FIG. 1). In the exemplary embodiment, the plurality of images 105 are related to the same property, item, place, person, and/or other desired object to be analyzed and classified. In some embodiments, the plurality of images 105 is provided by a user via a client device 405 (shown in FIG. 4). In other embodiments, the plurality of images 105 is provided by a third-party source, such as the third party server 425 (shown in FIG. 4). In one example, the plurality of images 105 are from a website, such as realty website.

In the exemplary embodiment, the HMIA server 410 retrieves 310 an image from the plurality of images 105. The HMIA server 410 executes 315 the hierarchy of models as shown in the HMIA system 200 (shown in FIG. 2) with the retrieved image as input. The execution 315 of the hierarchy of models generates classification information from each model that analyzes the image. The HMIA system 200 outputs 320 the classification information generated by the models that analyze the image. The HMIA system 200 associates 325 the classification information with the retrieved image. In some embodiments, the HMIA system 200 stores the classification information as metadata with the image. In other embodiments, the HMIA system 200 stores the classification information in a searchable database 420 (shown in FIG. 4).

If there are more images from the plurality of images 105, the HMIA system 200 retrieves 330 the next image and returns to Step 315. If there are no more images from the plurality of images 105, the HMIA system 200 generates 335 a report for the plurality of images 105 with the plurality of associated classification information. In some embodiments, the report is a real estate listing. In other embodiments, the report is used to validate information from one or more third party servers 425.

While the above describes using the systems and processes described herein for analyzing property, one having skill in the art would understand that these systems and methods may also be used for classifying items, such as vehicles, antiques, and/or other objects that need to be analyzed and classified.

### Exemplary System

FIG. 4 illustrates an exemplary system 400 for performing the process 300 (shown in FIG. 3) using the hierarchical model image analysis system 200 (shown in FIG. 2). In the example embodiment, the system 400 is used for analyzing image data to detect features in the images to classify the images. In some embodiments, the system 400 is also used to analyze the images of property to determine features of that property. In addition, the system 400 is a hierarchical model image analysis (HMIA) computer system configured to analyze and categorize images.

As described below in more detail, the HMIA server 410 is programmed to analyze images to identify classifications for them. In addition, the HMIA server 410 is programmed to train a plurality of models to be used in the hierarchical configuration of models to classify images. In some embodiments, the HMIA server 410 is programmed to execute the plurality of models as shown in FIG. 2. The HMIA server 410 is programmed to a) receive a plurality of images; b) retrieve an image from the plurality of models; c) execute the hierarchy of models with the retrieved image as input; d) output classification information for the retrieved image; e) associate the classification information with the retrieved image; f) if there are more images from the plurality of images, retrieve the next image and return to step c; and g) if there are no more images of the plurality of images, generate a report for the plurality of images with the plurality of associated classification information.

In the example embodiment, client devices 405 are computers that include a web browser or a software application, which enables client devices 405 to communicate with HMIA server 410 using the Internet, a local area network (LAN), or a wide area network (WAN). In some embodiments, the client devices 405 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Client devices 405 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, HMIA computer device 410 (also known as HMIA server 410) is a computer that include a web browser or a software application, which enables HMIA server 410 to communicate with client devices 405 using the Internet, a local area network (LAN), or a wide area network (WAN). In some embodiments, the HMIA server 410 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. HMIA server 410 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 415 is communicatively coupled to a database 420 that stores data. In one embodiment, the database 420 is a database that includes one or more classification models and/or classification information. In some embodiments, the database 420 is stored remotely from the HMIA server 410. In some embodiments, the database 420 is decentralized. In the example embodiment, a person can access the database 420 via the client devices 405 by logging onto HMIA server 410.

Third party servers 425 may be any third party server that HMIA server 410 is in communication with that provides additional functionality and/or information to HMIA server 410. For example, third party server 425 may provide images. In another example, third party server 425 is a municipal server and provides information about property that can be validated by the HMIA server 410. In the example embodiment, third party servers 425 are computers that include a web browser or a software application, which enables third party servers 425 to communicate with HMIA server 410 using the Internet, a local area network (LAN), or a wide area network (WAN). In some embodiments, the third party servers 425 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Third party servers 425 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

### Exemplary Client Device

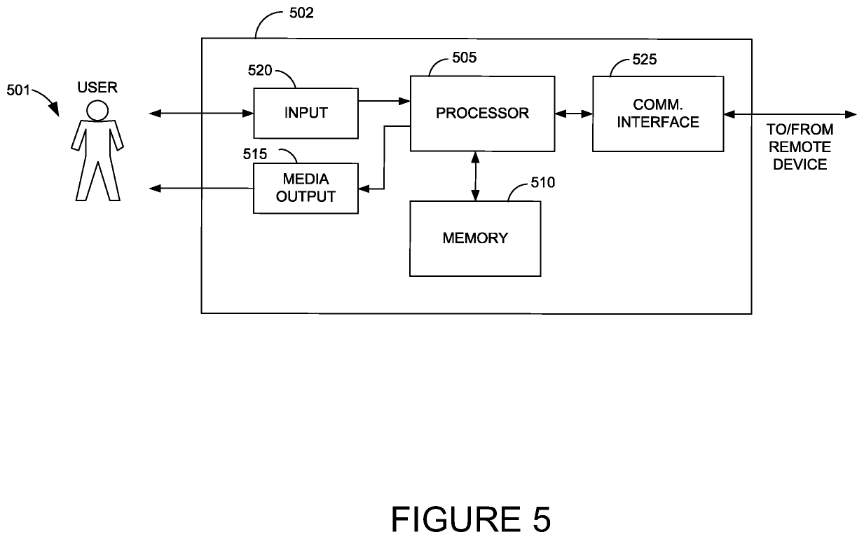

FIG. 5 depicts an exemplary configuration 500 of user computer device 502, in accordance with one embodiment of the present disclosure. In the exemplary embodiment, user computer device 502 may be similar to, or the same as, client device 405 (shown in FIG. 4). User computer device 502 may be operated by a user 501.

User computer device 502 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an interface for viewing items of information provided by the HMIA server 410 (shown in FIG. 4). In some embodiments, user computer device 502 may include an input device 520 for receiving input from user 501. User 501 may use input device 520 to, without limitation, provide information either through speech or typing.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as HMIA server 410. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from HMIA server 410. A client application may allow user 501 to interact with, for example, HMIA server 410. For example, instructions may be stored by a cloud service, and the output of the execution of the instructions sent to the media output component 515.

### Exemplary Server Device

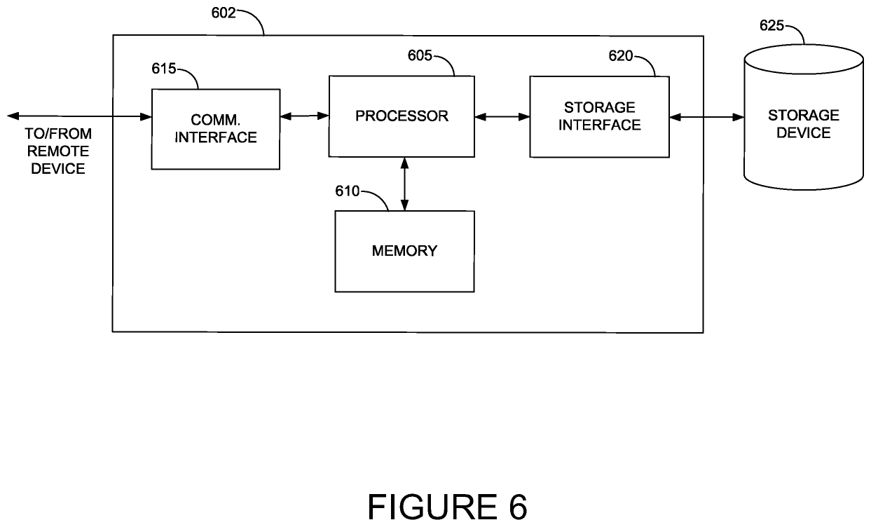

FIG. 6 depicts an exemplary configuration 600 of a server computer device 601, in accordance with one embodiment of the present disclosure. In the exemplary embodiment, server computer device 601 may be similar to, or the same as, HMIA computer device 410, database server 415, and third party server 425 (all shown in FIG. 4). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, HMIA computer device 410, third-party servers 425, and client devices 405 (shown in FIG. 4) (for example, using wireless communication or data transmission over one or more radio links or digital communication channels). For example, communication interface 615 may audio input from client devices 405 via the Internet, as illustrated in FIG. 4.

Processor 605 may also be operatively coupled to a storage device 625. Storage device 625 may be any computer-operated hardware suitable for storing and/or retrieving data, such as, but not limited to, data associated with one or more models. In some embodiments, storage device 625 may be integrated in server computer device 601. For example, server computer device 601 may include one or more hard disk drives as storage device 625.

In other embodiments, storage device 625 may be external to server computer device 601 and may be accessed by a plurality of server computer devices 601. For example, storage device 625 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 625 via a storage interface 620. Storage interface 620 may be any component capable of providing processor 605 with access to storage device 625. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 625.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIGS. 1 and 3.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, HMIA server 410 is configured to implement machine learning, such that HMIA server 410 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to: identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, convolution networks, recurrent networks, attention networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features. Such information may include, for example, information associated with a plurality of images of a plurality of different objects, items, and/or property. In some embodiments, the ML module may use synthetic data for training to increase the dataset and to include any know edge cases that may have a low frequency of occurrence.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments, and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed or used in conjunction with reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

### EXEMPLARY EMBODIMENTS

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: (1) receive a plurality of images; and/or (2) for each image of the plurality of images, the at least one processor is programmed to: (a) retrieve an image of the plurality of images; (b) execute a hierarchy of models with the retrieved image as input; (c) output classification information for the retrieved image based upon the execution; and/or (d) associate the classification information with the retrieved image. The system may include additional, less, or alternate functionality, including that discussed elsewhere herein.

An enhancement of the system may include a processor configured to generate a report for the plurality of images based upon the plurality of associated classification information. The images may be, for instance, retrieved from one or more memory units and/or acquired via one or more sensors, including cameras, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

A further enhancement of the system may include where the hierarchy of models includes a plurality of classification models, each trained to identify one or more items in an image. The system may also include where at least one of the plurality of classification models is trained to identify a material of an item in the image.

A further enhancement of the system may include a processor configured to route the retrieved image to a first classification model of the plurality of classification models in the hierarchy of models. The system may also execute the first classification model using the retrieved image as the input. The system may further receive one or more classifications from the first classification model based upon the retrieved image.

A further enhancement of the system may include a processor configured to determine a second classification model of the plurality of classification models in the hierarchy of models based upon the one or more classifications from the first classification model. The system may also route the retrieved image to the second classification model. The system may further execute the second classification model using the retrieved image as the input. In addition the system may receive one or more additional classifications from the second classification model based upon the retrieved image.

A further enhancement of the system may include a processor configured to determine a third classification model of the plurality of classification models in the hierarchy of models based upon the one or more additional classifications from the second classification model. The system may also route the retrieved image to the third classification model. The system may further execute the third classification model using the retrieved image as the input. In addition, the system may receive one or more further classifications from the third classification model based upon the retrieved image.

A further enhancement of the system may include where the plurality of images are of a property. The system may also include where the plurality of images include inside and outside images of at least one building on the property.

A further enhancement of the system may include where the plurality of images are of an object to be insured.

In another aspect, a computer-implemented method may be provided. The computer-implemented method may be performed by a hierarchical model image analysis (HMIA) computer device including at least one processor in communication with at least one memory device. The method may include: (1) receiving a plurality of images; and/or for each image of the plurality of images, the method further comprises: (a) retrieving an image of the plurality of images; (b) executing a hierarchy of models with the retrieved image as input; (c) outputting classification information for the retrieved image based upon the execution; and/or (d) associating the classification information with the retrieved image. The computer-implemented method may include additional, less, or alternate actions, including those discussed elsewhere herein.

An enhancement of the computer-implemented method may include generating a report for the plurality of images based upon the plurality of associated classification information.

A further enhancement of the computer-implemented method may include where the hierarchy of models includes a plurality of classification models, each trained to identify one or more items in an image. The method may also include where at least one of the plurality of classification models is trained to identify a material of an item in the image

A further enhancement of the computer-implemented method may include routing the retrieved image to a first classification model of the plurality of classification models in the hierarchy of models. The method may also include executing the first classification model using the retrieved image as the input. The method may further include receiving one or more classifications from the first classification model based upon the retrieved image.

A further enhancement of the computer-implemented method may include determining a second classification model of the plurality of classification models in the hierarchy of models based upon the one or more classifications from the first classification model. The method may also include routing the retrieved image to the second classification model. The method may further include executing the second classification model using the retrieved image as the input. In addition, the method may include receiving one or more additional classifications from the second classification model based upon the retrieved image.

A further enhancement of the computer-implemented method may include determining a third classification model of the plurality of classification models in the hierarchy of models based upon the one or more additional classifications from the second classification model. The method may also include routing the retrieved image to the third classification model. The method may further executing the third classification model using the retrieved image as the input. In addition, the method may include receiving one or more further classifications from the third classification model based upon the retrieved image.

A further enhancement of the computer-implemented method may include where the plurality of images are of a property. The method may also include where the plurality of images include inside and outside images of at least one building on the property.

A further enhancement of the computer-implemented method may include where the plurality of images are of an object to be insured.

In another aspect, at least one non-transitory computer-readable media having computer-executable instructions embodied thereon may be provided. When executed by a computing device including at least one processor in communication with at least one memory device, the computer-executable instructions may cause the at least one processor to: (1) receive a plurality of images; and/or (2) for each image of the plurality of images, the at least one processor is programmed to: (a) retrieve an image of the plurality of images; (b) execute a hierarchy of models with the retrieved image as input; (c) output classification information for the retrieved image based upon the execution; and/or (d) associate the classification information with the retrieved image. The computer-executable instructions may direct additional, less, or alternate functionality, including that discussed elsewhere herein.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer system comprising at least one processor in communication with at least one memory device, wherein the at least one processor programmed to:
receive a plurality of images; and
for each image of the plurality of images, the at least one processor is programmed to:
retrieve an image of the plurality of images;
execute a hierarchy of models with the retrieved image as input;
output classification information for the retrieved image based upon the execution; and
associate the classification information with the retrieved image.

2. The computer system of claim 1, where in the at least one processor is further programmed to generate a report for the plurality of images based upon the plurality of associated classification information.

3. The computer system of claim 1, wherein the hierarchy of models includes a plurality of classification models, each trained to identify one or more items in an image.

4. The computer system of claim 3, wherein at least one of the plurality of classification models is trained to identify a material of an item in the image.

5. The computer system of claim 3, wherein the at least one processor is further programmed to:
route the retrieved image to a first classification model of the plurality of classification models in the hierarchy of models;
execute the first classification model using the retrieved image as the input; and
receive one or more classifications from the first classification model based upon the retrieved image.

6. The computer system of claim 5, wherein the at least one processor is further programmed to:
determine a second classification model of the plurality of classification models in the hierarchy of models based upon the one or more classifications from the first classification model;
route the retrieved image to the second classification model;
execute the second classification model using the retrieved image as the input; and
receive one or more additional classifications from the second classification model based upon the retrieved image.

7. The computer system of claim 6, wherein the at least one processor is further programmed to:
determine a third classification model of the plurality of classification models in the hierarchy of models based upon the one or more additional classifications from the second classification model;
route the retrieved image to the third classification model;
execute the third classification model using the retrieved image as the input; and
receive one or more further classifications from the third classification model based upon the retrieved image.

8. The computer system of claim 1, wherein the plurality of images are of a property.

9. The computer system of claim 8, wherein the plurality of images include inside and outside images of at least one building on the property.

10. The computer system of claim 1, wherein the plurality of images are of an object to be insured.

11. A computer-implemented method performed by a hierarchical model image analysis (HMIA) computer device including at least one processor in communication with at least one memory device, the method comprising:
receiving a plurality of images; and
for each image of the plurality of images, the method further comprises:
retrieving an image of the plurality of images;
executing a hierarchy of models with the retrieved image as input;
outputting classification information for the retrieved image based upon the execution; and
associating the classification information with the retrieved image.

12. The computer-implemented method of claim 11 further comprising generating a report for the plurality of images based upon the plurality of associated classification information.

13. The computer-implemented method of claim 11, wherein the hierarchy of models includes a plurality of classification models, each trained to identify one or more items in an image.

14. The computer-implemented method of claim 13, wherein at least one of the plurality of classification models is trained to identify a material of an item in the image.

15. The computer-implemented method of claim 13 further comprising:
routing the retrieve image to a first classification model of the plurality of classification models in the hierarchy of models;
executing the first classification model using the retrieved image as the input; and
receiving one or more classifications from the first classification model based upon the retrieved image.

16. The computer-implemented method of claim 15 further comprising:
determining a second classification model of the plurality of classification models in the hierarchy of models based upon the one or more classifications from the first classification model;
routing the retrieved image to the second classification model;
executing the second classification model using the retrieved image as the input; and
receiving one or more additional classifications from the second classification model based upon the retrieved image.

17. The computer-implemented method of claim 16 further comprising:
determining a third classification model of the plurality of classification models in the hierarchy of models based upon the one or more additional classifications from the second classification model;
routing the retrieved image to the third classification model;
executing the third classification model using the retrieved image as the input; and
receiving one or more further classifications from the third classification model based upon the retrieved image.

18. The computer-implemented method of claim 11, wherein the plurality of images are of a property.

19. The computer-implemented method of claim 18, wherein the plurality of images include inside and outside images of at least one building on the property.

20. At least one non-transitory computer-readable media having computer-executable instructions embodied thereon, wherein when executed by a computing device including at least one processor in communication with at least one memory device, the computer-executable instructions cause the at least one processor to:
receive a plurality of images; and
for each image of the plurality of images, the at least one processor is programmed to:
retrieve an image of the plurality of images;
execute a hierarchy of models with the retrieved image as input;
output classification information for the retrieved image based upon the execution; and
associate the classification information with the retrieved image.
